(19) United States
(12) Patent Application Publication
(10) Pub. No.: US 2026/0038841 A1
(43) Pub. Date: Feb. 5, 2026

(54) COMPOSITE POSITIVE ELECTRODE ACTIVE MATERIAL, POSITIVE ELECTRODE CONTAINING THE SAME, AND ALL-SOLID-STATE BATTERY CONTAINING THE SAME

(71) Applicant: UIF (University Industry Foundation), Yonsei University, Seoul (KR)

(72) Inventors: Yoon Seok Jung, Seoul (KR); Jun Pyo Son, Seoul (KR); Donghyuk Kim, Seoul (KR); Juhyoun Park, Bucheon-si (KR)

(21) Appl. No.: 19/280,651

(22) Filed: Jul. 25, 2025

(30) Foreign Application Priority Data
Jul. 25, 2024 (KR) 10-2024-0098692

(51) Int. Cl. H01M 4/62; C01G 23/00; H01M 4/02; H01M 4/36; H01M 4/505; H01M 10/0562

(52) U.S. Cl. CPC H01M 4/628; C01G 23/002; H01M 4/366; H01M 4/505; H01M 10/0562; C01P 2002/72; C01P 2002/85; C01P 2004/03; C01P 2004/80; C01P 2006/40; H01M 2004/028; H01M 2300/0068

(57) ABSTRACT

An embodiment provides a composite positive electrode active material including: a positive electrode active material represented by Chemical Formula 1; and a coating layer on a surface of the positive electrode active material, the coating layer including a compound represented by Chemical Formula 2.

Chemical Formula 1 and Chemical Formula 2 are as described in the specification.

### CROSS-REFERENCE TO RELATED APPLICATION

This application claims priority to and the benefit of Korean Patent Application No. 10-2024-0098692 filed with the Korean Intellectual Property Office on Jul. 25, 2024, the entire contents of which are incorporated herein by reference.

### BACKGROUND OF THE INVENTION

### (a) Field of the Invention

This disclosure relates to a composite positive electrode active material, a positive electrode including the same, and an all-solid-state battery including the same.

### (b) Description of the Related Art

Recently, lithium ion batteries are expanding from power sources for small mobile devices to power sources for electric vehicles and energy storage devices (ESS) such as medium and large-sized pure electric vehicles (EVs) and hybrid electric vehicles (HEVs). In particular, interest in electric vehicles, which are eco-friendly vehicles, is very high, and major automakers around the world are accelerating technology development by recognizing electric vehicles as a next-generation growth technology under the motto of eco-friendliness. In the case of medium-sized and large-sized lithium-ion batteries, unlike small-sized lithium-ion batteries, it is essential to secure safety because they include many batteries as well as harsh operating environments such as temperature or shock. Accordingly, as industrial fields requiring lithium ion batteries expand their application range to large batteries, interest in safety issues of lithium ion batteries is also greatly increasing.

Existing lithium-ion batteries have problems such as low thermal stability, ignitability, and leakage because organic liquid electrolytes are used. In fact, as explosion accidents of products applied with this technology are continuously reported, it is urgently required to solve these problems. Accordingly, an all-solid-state battery using a solid electrolyte is emerging as an alternative.

Sulfide-based solid electrolytes are attracting much attention as materials suitable for all-solid-state batteries due to their high ionic conductivity and soft mechanical properties, but they are electrochemically unstable. This may cause serious side reactions when in direct contact with 5V-class positive electrode active materials.

Accordingly, research is being developed to create a shell-shaped oxide-based solid electrolyte on the positive electrode active material to prevent direct contact between the sulfide-based solid electrolyte and the 5V-class positive electrode active material.

However, although the oxide-based solid electrolyte shell can suppress the side reactions of the sulfide-based solid electrolyte, it has a problem in that it acts as a resistive layer inside the all-solid-state battery due to its low ionic conductivity, causing a decrease in performance of the all-solid-state battery.

### SUMMARY OF THE INVENTION

An embodiment provides a composite positive electrode active material having excellent ionic conductivity and electrochemical stability.

Another embodiment provides a positive electrode comprising the composite positive electrode active material.

Another embodiment provides an all-solid-state battery having excellent charge/discharge characteristics and cycle-life characteristics, by including the positive electrode.

A composite positive electrode active material according to an embodiment includes a positive electrode active material represented by Chemical Formula 1; and a coating layer disposed on a surface of the positive electrode active material and including a compound represented by Chemical Formula 2.

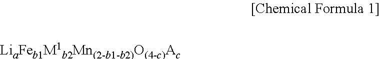

In Chemical Formula 1, M1 is Mg, B, Al, or a combination thereof; A is F, Cl, Br, I, or a combination thereof; 1≤a≤2, 0≤b1<2, 0≤b2<2, (2−b1−b2)>0, and 0≤c<4;

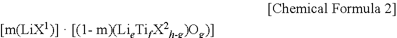

wherein, in Chemical Formula 2, X¹ and X² are each independently F, Cl, Br, I, or a combination thereof; 0.01≤e≤10, 0.01≤f≤10, 0≤g<h, and 0<m<1.

A positive electrode according to another embodiment includes a positive electrode current collector; and a positive electrode active material layer on the positive electrode current collector, wherein the positive electrode active material layer includes the composite positive electrode active material.

An all-solid-state battery according to another embodiment includes the positive electrode; a negative electrode; and a solid electrolyte layer between the positive electrode and the negative electrode.

The composite positive electrode active material according to an embodiment has the advantages of excellent ionic conductivity and electrochemical stability.

An all-solid-state battery according to another embodiment has the advantage of excellent charge/discharge characteristics and cycle-life characteristics by including the composite positive electrode active material.

### BRIEF DESCRIPTION OF THE DRAWINGS

FIG. 1 is a cross-sectional view of an all-solid-state battery according to an embodiment.

FIG. 2 is a graph showing the XRD evaluation results of the coating material used in Synthesis Example 1 and Comparative Synthesis Example 1.

FIG. 3 is a graph showing the XRD evaluation results of the coating material used in Comparative Synthesis Example 2 and Comparative Synthesis Example 3.

FIG. 4 is a graph showing the results of evaluating the ionic conductivity of the coating material used in Synthesis Example 1 and Comparative Synthesis Example 1.

FIG. 5 is a graph showing the results of evaluating the ionic conductivity of the coating material used in Comparative Synthesis Example 2 and Comparative Synthesis Example 3.

FIG. 6 is a graph showing the results of cyclic voltammetry evaluation of the coating materials used in Synthesis Example 1, and Comparative Synthesis Examples 1 to 4.

FIG. 7 is an image of the composite positive electrode active material prepared in Synthesis Example 2 observed using a scanning electron microscope (SEM).

FIG. 8 is an image of (a) a composite positive electrode active material prepared in Synthesis Example 2 analyzed by SEM-EDS (Energy Dispersive Spectrometer), (b) an image of Ti mapping, (c) an image of Fe mapping, and (d) an image of Fe and Ti mapping.

FIG. 9 shows the results of X-ray photoelectron spectroscopy (XPS) analysis for the composite positive electrode active material prepared in Synthesis Example 2.

FIGS. 10 to 13 are graphs showing the rate characteristics evaluation according to the initial cycle of the all-solid-state battery cells manufactured in Examples 1 to 3.

FIG. 14 is a graph evaluating the initial charge/discharge characteristics of the all-solid-state battery cell manufactured in Example 2.

FIGS. 15 to 18 are graphs evaluating the initial charge/discharge characteristics of the all-solid-state battery cells manufactured in Comparative Examples 1 to 4.

FIGS. 19 and 20 are graphs evaluating the initial charge/discharge characteristics of the all-solid-state battery cells manufactured in Examples 2 and 4.

### DETAILED DESCRIPTION OF THE EMBODIMENTS

Hereinafter, embodiments will be described in detail so that those skilled in the art can easily implement them. However, a structure actually applied may be implemented in many different forms and is not limited to the implementation described herein.

In the drawings, the thickness of layers, films, panels, regions, etc., are exaggerated for clarity. It will be understood that when an element such as a layer, film, region, or substrate is referred to as being “on” another element, it may be directly on the other element or intervening elements may also be present. In contrast, when an element is referred to as being “directly on” another element, there are no intervening elements present.

In the drawings, parts having no relationship with the description are omitted for clarity of the embodiments, and the same or similar constituent elements are indicated by the same reference numerals throughout the specification.

Hereinafter, the terms “lower” and “upper” are used for better understanding and ease of description, but do not limit the position relationship.

Hereinafter, unless otherwise defined, ‘metal’ includes metal and semimetal.

As used herein, “combination thereof” means a mixture, a laminate, a composite, a copolymer, an alloy, a blend, a reaction product, and the like of the constituents.

Hereinafter, a composite positive electrode active material according to an embodiment is described.

### Composite Positive Electrode Active Material

The composite positive electrode active material according to an embodiment includes a positive electrode active material represented by Chemical Formula 1; and a coating layer disposed on a surface of the positive electrode active material and including a compound represented by Chemical Formula 2.

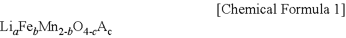

In Chemical Formula 1, M1 is Mg, B, Al, or a combination thereof; A is F, Cl, Br, I, or a combination thereof; 1≤a≤2, 0≤b1<2, 0≤b2<2, (2−b1−b2)>0, and 0≤c<4;

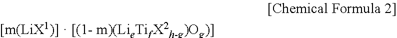

In Chemical Formula 2, X¹ and X² are each independently F, Cl, Br, I, or a combination thereof; 0.01≤e≤10, 0.01≤f≤10, 0≤g<h, and 0<m<1.

Generally, a surface of a 5V-class positive electrode active material with a lithium chloride compound has been coated, but the lithium chloride compound has a problem of poor electrochemical stability. In addition, when coating a lithium fluoride compound instead of the lithium chloride compound, there is a problem that although electrochemical stability may be increased, lithium ionic conductivity may be low, which could increase resistance inside the battery.

Accordingly, in an embodiment, a composite active material capable of implementing high ionic conductivity while increasing electrochemical stability is provided by coating a combined fluoride compound on the surface of a 5V-class positive electrode active material.

Compared to similar spinel-based materials like lithium nickel manganese oxide, the compound of Chemical Formula 1 has the advantages of being based on inexpensive and abundant iron, and exhibiting a higher redox potential for iron than that of nickel.

The compound represented by Chemical Formula 2 may be a compound in which a lithium halide and a lithium titanium halide (e.g., lithium metal fluoride or lithium titanium oxyfluoride) are combined. For example, the compound represented by Chemical Formula 2 is a compound in which lithium halide and lithium titanium fluoride are combined, and since it has higher lithium ionic conductivity than lithium fluoride, when it is used as a coating material for a positive electrode active material, the performance of an all-solid-state battery may not be reduced.

When such a composite positive electrode active material is applied to an all-solid-state battery, the composite positive electrode active material has high electrochemical stability, so that side reactions with a solid electrolyte may be suppressed, thereby realizing an all-solid-state battery with excellent performance.

In Chemical Formula 1, X¹ and X² may be different from each other.

In an embodiment, the positive electrode active material may be LiFe_{0.5}Mn_{1.5}O₄ or LiFe_{0.4}Al_{0.1}Mn_{1.5}O₄.

For example, the positive electrode active material may be in the form of particles, and the positive electrode active material may include a single crystal, a polycrystal formed by an aggregate thereof, or a combination thereof.

The single crystal may mean a minimum unit of particles constituting the positive electrode active material, and may mean a minimum unit judged from the external geometric shape.

The average particle size (D₅₀) of the positive electrode active material in single crystal form may be 4 μm to 10 μm, for example, 5 μm to 10 μm, or 5 μm to 8 μm.

The average particle size (D₅₀) of the positive electrode active material in polycrystalline form may be 10 μm to 20 μm, for example, 12 μm to 20 μm, or 12 μm to 18 μm.

Here, the average particle size may be obtained by selecting 20 or so random particles from a scanning electron microscope image of the positive electrode active material, measuring their particle sizes (diameter, major axis, or major axis length), obtaining a particle size distribution, and then taking the diameter (D₅₀) of the particles having a cumulative volume of 50 vol % from the particle size distribution as the average particle size.

In an embodiment, the compound represented by Chemical Formula 2 may include a compound represented by Chemical Formula 2A:

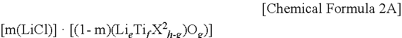

wherein, in Chemical Formula 2A, 0.01≤e≤10, 0.01≤f≤10, 0≤g<h, and 0<m<1.

For example, the compound represented by Chemical Formula 2 may include a compound represented by Chemical Formula 2A:

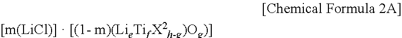

wherein, in Chemical Formula 2A, 0.01≤e≤10, 0.01≤f≤10, 0≤g<h, and 0<m<1.

In addition, m and (1-m) of the compound represented by Chemical Formula 2 may be in a molar ratio of 1:1 to 1:9, 1:2 to 1:5, 1:3 to 1:5, or 1:3 to 1:4.

For example, the compound represented by Chemical Formula 2 may be LiCl·4Li₂TiF₆.

The lithium ionic conductivity of the compound represented by Chemical Formula 2 may be greater than or equal to 1.0×10⁻⁶ S/cm, for example, greater than or equal to 2.0×10⁻⁶ S/cm, greater than or equal to 5.0×10⁻⁶ S/cm, or greater than or equal to 1.0×10⁻⁵ S/cm, and there is no upper limit.

In an embodiment, the coating layer may be included in an amount of 1 part by weight to 20 parts by weight, for example, 5 parts by weight to 20 parts by weight, 1 part by weight to 15 parts by weight, or 5 parts by weight to 15 parts by weight, based on 100 parts by weight of the positive electrode active material.

When the above numerical range is satisfied, a composite positive electrode active material having both excellent electrochemical stability and ionic conductivity may be realized.

### Method of Preparing Composite Positive Electrode Active Material

Hereinafter, a method for preparing a composite positive electrode active material is described.

A method of preparing a composite positive electrode active material according to an embodiment includes: (1) preparing the aforementioned compound represented by Chemical Formula; and (2) mixing the positive electrode active material and the compound in a solid phase and coating the compound on the surface of the positive electrode active material.

First, the step (1) of preparing the compound represented by Chemical Formula 2 may include solid-state mixing a lithium halide and a lithium metal halide (e.g., lithium metal fluoride or lithium titanium oxyfluoride).

The lithium halide may include LiCl, LiBr, LiI, or a combination thereof.

For example, the lithium titanium halide may be represented by LiₑTi_{f}X²_{h-g}O_{g}, wherein X² is F, Cl, Br, I, or a combination thereof; 0.01≤e≤10, 0.01≤f≤10, 0≤g<h, and 0<m<1.

For example, in the lithium titanium halide represented by LiₑTi_{f}X²_{h-g}O_{g}, when g and h satisfy 0<g<h, a solid-phase mixture may further include an oxygen supplying material, and the oxygen supplying material may be lithium oxide (Li₂O).

For example, the lithium titanium fluoride may include Li₂TiF₆.

The solid-state mixing of the lithium halide and the lithium metal halide may be performed by any one mechanical milling selected from a ball mill, a vibration mill, a turbo mill, a mechanofusion, and a disk mill, and can be desirably performed by a ball mill or a vibration mill.

For example, the mechanical milling can be performed at a rotation speed of 300 to 800 rpm. For example, the mechanical milling may be performed for 10 to 50 hours, and as a specific example, it may be performed for 7 to 18 hours at a rotation speed of 500 to 700 rpm, and as a most specific example, it may be performed for 9 to 11 hours at a rotation speed of 580 to 620 rpm.

The positive electrode active material is coated with the compound represented by Chemical Formula 2 prepared above (step (2)).

The positive electrode active material is represented by Chemical Formula 1 and is as described above, and a detailed description is omitted here.

In the step (2) of coating the compound on the surface of the positive electrode active material, the coating may be performed by any one mechanical milling selected from a ball mill, a vibration mill, a turbo mill, a mechanofusion, and a disk mill, and may desirably be performed by a ball mill or a vibration mill.

For example, the mechanical milling may be performed at a rotation speed of 100 to 800 rpm for 0.5 to 10 hours, specifically at a rotation speed of 200 to 300 rpm for 0.5 to 3 hours, and most specifically at a rotation speed of 180 to 230 rpm for 0.5 to 1 hour.

### All-Solid-State Battery

Another embodiment provides an all-solid-state battery including a positive electrode including the composite positive electrode active material; a negative electrode; and a solid electrolyte between the positive electrode and the negative electrode.

When the aforementioned composite positive electrode active material is applied to an all-solid-state battery, an all-solid-state battery with excellent performance in terms of charge/discharge characteristics and cycle-life characteristics may be realized.

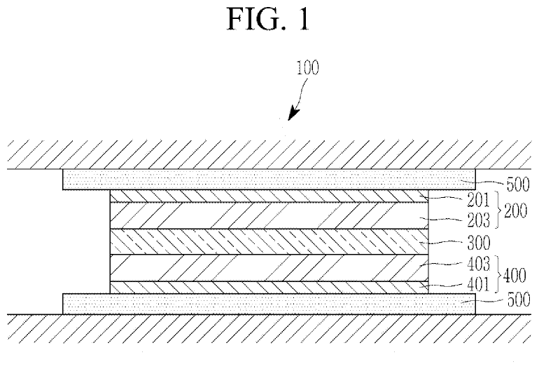

Hereinafter, an all-solid-state battery is described with reference to FIG. 1.

FIG. 1 is a cross-sectional view of an all-solid-state battery according to an embodiment. Referring to FIG. 1, an all-solid-state battery 100 have a structure in which an electrode assembly including a negative electrode 400 including a negative electrode current collector 401 and a negative electrode active material layer 403, a solid electrolyte layer 300, and a positive electrode 200 including positive electrode active material layer 203 and a positive electrode current collector 201 which are stacked and stored in a case such as a pouch. The all-solid-state battery 100 may further include an elastic layer 500 on the outside of at least one of the positive electrode 200 and the negative electrode 400. Although one electrode assembly including a negative electrode 400, a solid electrolyte layer 300, and a positive electrode 200 is shown in FIG. 1, an all-solid-state battery may be manufactured by stacking two or more electrode assemblies.

Also, as a device including an all-solid-state battery according to an embodiment may be any one selected from a communication device, a transportation device, and an energy storage device.

Also, as an electric device including an all-solid-state battery according to an embodiment, the electric device may be one selected from electric vehicles, hybrid electric vehicles, plug-in hybrid electric vehicles, and power storage devices.

The charge voltage of the all-solid-state battery according to an embodiment may be greater than or equal to 4.2 V, for example greater than or equal to 4.5 V, greater than or equal to 4.6 V, greater than or equal to 4.8 V, or greater than or equal to 5 V.

The discharge voltage of the all-solid-state battery according to an embodiment may be less than or equal to 3.5 V, for example less than or equal to 3.0 V, less than or equal to 2.5 V, or less than or equal to 2.3 V.

An all-solid-state battery satisfying the above numerical ranges of charge voltage and discharge voltage has the advantage of excellent charge/discharge characteristics and cycle-life characteristics when driven by high-voltage charge or low-voltage discharge.

### Positive Electrode

The positive electrode 200 may include a positive electrode current collector 201 and a positive electrode active material layer 203 on the positive electrode current collector 201.

The positive electrode active material layer 203 includes the aforementioned composite positive electrode active material and may optionally further include a solid electrolyte.

In an embodiment, the solid electrolyte included in the positive electrode active material layer 203 may include a halide-based solid electrolyte, a sulfide-based solid electrolyte, an oxide-based solid electrolyte, a complex hydride, or a combination thereof, and the types of solid electrolytes that may be included in the positive electrode active material layer 203 will be described later in the section on the solid electrolyte layer.

For example, the solid electrolyte included in the positive electrode active material layer 203 may be a halide-based solid electrolyte, and when the above-described composite positive electrode active material and the halide-based solid electrolyte are used in combination, the high-voltage stability of the all-solid-state battery can be further improved.

For example, a weight ratio of the composite positive electrode active material and the solid electrolyte included in the positive electrode active material layer 203 may be 30:70 to 70:30, for example, 40:60 to 60:40, or 45:55 to 55:45.

### Negative Electrode

The negative electrode 400 may be a general negative electrode including various negative electrode active materials such as carbon-based and silicon-based materials, or may be a negative electrode made of a metal such as lithium metal, and may be a precipitation-type negative electrode in which no negative electrode active material is present initially and lithium metal or the like is precipitated during charging to serve as a negative electrode active material.

For example, the negative electrode 400 may include a negative electrode current collector 401 and a negative electrode active material layer 403 on the negative electrode current collector 401. The negative electrode active material layer 403 may include a negative electrode active material and optionally may include a solid electrolyte. The solid electrolyte that may be included in the negative electrode active material layer 203 will be described later in the section on the solid electrolyte layer.

The negative electrode active material may include a material capable of reversibly intercalating/deintercalating lithium ions, lithium metal, an alloy of lithium metal, a material capable of doping and dedoping lithium, or a transition metal oxide.

The material capable of reversibly intercalating/deintercalating lithium ions is a carbon-based negative electrode active material, and may include, for example, crystalline carbon, amorphous carbon, or a combination thereof.

Examples of crystalline carbon include natural graphite, artificial graphite, or a combination thereof, and examples of amorphous carbon include soft carbon or hard carbon, a mesophase pitch carbonized product, and calcined coke. The carbon-based negative electrode active material may have irregular, plate-like, flake-like, spherical, or fibrous shape.

The lithium metal alloy may be an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping and dedoping the lithium may be a Si-based negative electrode active material or a Sn-based negative electrode active material. The Si-based negative electrode active material may include silicon, a silicon-carbon composite, SiOₓ (0<x<2), a silicon alloy, etc., and the Sn-based negative electrode active material may include Sn, SnO₂, a tin alloy, etc., and at least one of these can be mixed and used with SiO₂. For example, the negative electrode active material may include a composite of silicon and carbon.

### Solid Electrolyte Layer

The solid electrolyte layer 300 includes a solid electrolyte, and the solid electrolyte may include a sulfide-based solid electrolyte.

The sulfide-based solid electrolyte may be divided into a crystalline solid electrolyte and a non-crystalline solid electrolyte depending on the presence or absence of a crystal structure. Representative crystalline solid electrolyte may include Thio-LISICON such as Li_{3.25}Ge_{0.25}P_{0.75}S₄, LGPS such as Li₁₀GeP₂S₁₂, and argyrodite structure such as Li₆PS₅Cl. The non-crystalline solid electrolyte may be divided into a glass-based solid electrolyte and a glass-ceramic-based solid electrolyte depending on the difference in heat treatment temperature. Examples of the glass-based solid electrolyte may include 30Li₂S·26B₂S₃·44LiO, 63Li₂S·36SiS₂·1 Li₃PO₄, 57Li₂S·38SiS₂·5Li₄SiO₄, and examples of glass-ceramic-based solid electrolyte include Li_{3.25}P_{0.95}S₄, Li₇P₃S₁₁, and the like.

The sulfide-based solid electrolyte may be classified into an argyrodite structure, a binary structure such as Li₂S—P₂S₅, and a ternary structure such as Li₂S—GeS₂—P₂S₅.

The sulfide-based solid electrolyte may be an argyrodite-type sulfide-based solid electrolyte. The argyrodite is one of the solid electrolytes that exhibits lithium ionic conductivity and has the same structure as the mineral Ag₉GeS₆. Li-argyrodite with Li⁺ conductivity may typically be Li₇PS₆ and Li₆PS₅X (X=Cl, Br, or I). Common methods for synthesizing the argyrodite-type sulfide-based solid electrolyte may include mechanical milling, post-milling annealing, solid-state sintering, and liquid-phase methods.

It has been reported that Li₇PS₆, that is an argyrodite type, has a cubic phase at a high temperature, an orthorhombic phase at a low temperature, and a cubic phase at a high temperature, which exhibits improved ionic conductivity. This compound can be stabilized by substituting sulfur with a halogen anion. As the halogen element is substituted, a vacancy is formed in the lithium site portion inside the argyrodite unit cell, which improves the lithium ionic conductivity. Due to the substitution of the halogen ion, the cubic phase is stabilized even at room temperature, so that, for example, Li₆PS₅Br and Li₆PS₅Cl can exhibit high ionic conductivities of greater than or equal to 10⁻³ S/cm.

For example, the argyrodite-type sulfide-based solid electrolyte may include Li₇PS₅Br, Li₅PS₄Cl₂, Li₆PS₅Cl, Li₆PS₅Br, Li₆PS₅I, Li₇P₂S₈I, Li₄PS₄₁, Li_{9.54}Si_{1.74}P_{1.44}S_{11.7}Cl_{0.3}, Li₇P_{2.9}Mn_{0.1}S_{10.7}I_{0.3}, or a combination thereof, but is not limited thereto.

For example, the sulfide-based solid electrolyte may include Li_{7+x-y}Mₓ⁴⁺M₁₋ₓ⁵⁺S_{6-y}X_{y} (M⁴⁺:Si, Ge, S or Sn; M⁵⁺:P or Sb; X: Cl, Br, or I, 0≤x≤1, 0≤y≤2), Li₁₀₊ₐ[Ge_{b}M⁴⁺_{1-b}]₁₊ₐP₂ₐS_{12-c}X_{c} (M⁴⁺: Si or Sn; X: Cl, Br, or I, 0≤a≤2, 0≤b≤1, 0≤c≤4), or a combination thereof.

The sulfide-based solid electrolyte is in the form of particles and may have an average particle diameter (D₅₀) of less than or equal to 5.0 μm, for example, 0.1 μm to 5.0 μm, 0.5 μm to 5.0 μm, 0.5 μm to 4.0 μm, 0.5 μm to 3.0 μm, 0.5 μm to 2.0 μm, or 0.5 μm to 1.0 μm. The sulfide-based solid electrolyte may achieve high ionic conductivity and have excellent contact with the positive electrode active material and connectivity between solid electrolyte particles.

The solid electrolyte layer 300 may further include a solid electrolyte other than the aforementioned sulfide-based solid electrolyte, and may further include, for example, an oxide-based solid electrolyte, a halide-based solid electrolyte, a complex hydride, or a combination thereof.

The oxide-based solid electrolyte may include, for example Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), PB(Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y} PO₄₃, 0<x<2, 0<y<3), Li_{1+x+y}(Al,Ga)ₓ(Ti,Ge)₂₋ₓSi_{y}P_{3-y}O₁₂ (0≤x≤1, 0≤y≤1), lithium titanium phosphate (LiₓTi_{y}(PO₄)₃, 0<x<2, 0<y<3), Li₂O, LiAlO₂, Li₂O—Al₂O₃—SiO₂—P₂O₅—TiO₂—GeO₂ ceramics, garnet-type ceramics Li₃₊ₓLa₃M₂O₁₂ (M=Te, Nb, or Zr, and x is an integer from 1 to 10), or a combination thereof.

The halide-based solid electrolyte includes a halogen element as a main component, and a ratio of the halogen element to all elements constituting the solid electrolyte may be greater than or equal to 50 mol %, greater than or equal to 70 mol %, greater than or equal to 90 mol %, or 100 mol %.

The halide-based solid electrolyte may include a lithium element, a metal element other than lithium, and a halogen element. The metal element other than lithium may be, for example, Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof. The halogen element may be F, Cl, Br, I, or a combination thereof, for example Cl, Br, or a combination thereof.

For example, the halide-based solid electrolyte may include at least one of the compounds represented by Chemical Formula 3 to Chemical Formula 6.

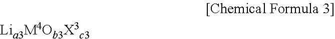

In Chemical Formula 3,
M⁴ may be Al, As, B, Bi, Ca, Cd, Co, Cr, Fe, Ga, Hf, In, Mg, Mn, Nb, Ni, Sb, Sc, Sn, Ta, Ti, Y, Yb, Zn, Zr, or a combination thereof,
X³ may be F, Cl, Br, I, or a combination thereof,
1≤a3≤3, 0≤b3≤1, and 4≤c3≤6.

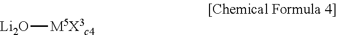

In Chemical Formula 4,
M⁵ may be Al, As, B, Bi, Ca, Cd, Co, Cr, Fe, Ga, Hf, In, Mg, Mn, Nb, Ni, Sb, Sc, Sn, Ta, Ti, Y, Yb, Zn, Zr, or a combination thereof,
X³ may be F, Cl, Br, I, or a combination thereof, and 4≤c4≤6.

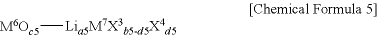

In Chemical Formula 5,
M⁶ and M⁷ may be the same or different and may each independently be Mg, Ca, Zn, Cd, Cu, Sc, Y, B, Al, Ga, In, Ln, La, Ce, Pr, Nd, Pm, Sm, Eu, Gd, Tb, Dy, Ho, Er, Yb, Lu, Ti, Zr, Hf, Nb, Ta, Mo, W, Sb, Si, Ge, Sn, V, Cr, Mn, Fe, Co, Ni, or a combination thereof,
X³ and X⁴ may be different and may each independently be Cl, Br, F, or I,
0.01≤a5≤10, 0.01≤b5≤10, 0.01≤c5≤10, and 0.01≤d5≤4.

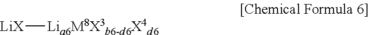

In Chemical Formula 6,
M⁸ may be Mg, Ca, Zn, Cd, Cu, Sc, Y, B, Al, Ga, In, Ln, La, Ce, Pr, Nd, Pm, Sm, Eu, Gd, Tb, Dy, Ho, Er, Yb, Lu, Ti, Zr, Hf, Nb, Ta, Mo, W, Sb, Si, Ge, Sn, V, Cr, Mn, Fe, Co, Ni, or a combination thereof,
X may be Cl, Br, F, or I,
X³ and X⁴ may be different and may each independently be Cl, Br, F, or I,
0.01≤a6≤10, 0.01≤b6≤10, 0.01≤c6≤10, and 0.01≤d6≤4.

For example, the halide-based solid electrolyte may include Li₂ZrCl₆, Li_{2.7}Y_{0.7}Zr_{0.3}Cl₆, Li_{2.5}Y_{0.5}Zr_{0.5}Cl₆, Li_{2.5}In_{0.5}Zr_{0.5}Cl₆, Li₂In_{0.5}Zr_{0.5}Cl₆, Li₃YBr₆, Li₃YCl₆, Li₃YBr₂Cl₄, Li₃YbCl₆, Li_{2.6}Hf_{0.4}Yb_{0.6}Cl₆, LiAlCl₄, LiNbOCl₄, LiTaOCl₄, or a combination thereof.

For example, the halide-based solid electrolyte may be Li₂ZrCl₆, Li_{2.7}Y_{0.7}Zr_{0.3}Cl₆, Li_{2.5}Y_{0.5}Zr_{0.5}Cl₆, Li_{2.5}In_{0.5}Zr_{0.5}Cl₆, Li₂In_{0.5}Zr_{0.5}Cl₆, Li₃YBr₆, Li₃YCl₆, Li₃YBr₂Cl₄, Li₃YbCl₆, Li_{2.6}Hf_{0.4}Yb_{0.6}Cl₆, LiAlCl₄, LiNbOCl₄, LiTaOCl₄, Li₂O—TaCl₅, MgO—Li₂ZrCl₆, Al₂O₃-3Li₂ZrCl₆, Al₂O₃-2Li₃YCl₆, Al₂O₃-3Li₂ZrCl₆, 3ZrO₂₋₄Li₃YCl₆, ZrO₂-2Li₂ZrCl₆, ZrO₂-2Li₂ZrCl₅F, SiO₂-2Li₂ZrCl₆, SnO₂-2Li₂ZrCl₆, or a combination thereof.

The complex hydride may be, for example, MM′Hₙ composed of a metal cation (M) and a complex-anion M′Hₙ. The metal cation (M) may be, for example, Li, Na, K, Mg, Sc, Cu, Zn, Zr, or Hf, and the complex-anion can be [BH₄]⁻, [NH₂]⁻, [AlH₄]⁻, [NH]²⁻, [AlH₆]³⁻, or [NiH₄]⁴⁻. The complex hydride may be referred to the literature “M. Matsuo, S.-i. Orimo, Adv. Energy Mater. 2011, 1, 161.”

Hereinafter, various examples and experimental examples of the present invention will be described in detail. However, the following examples are merely some examples of the present invention, and the present invention should not be construed as being limited to the following examples.

### Synthesis Examples: Preparation of Composite Positive Electrode Active Material

### Synthesis Example 1

First, LiCl and Li₂TiF₆ are weighed to be included in a molar ratio of 1:4 and then, mechanically milled by using Pulverisette 7 PL (Fritsch GmbH) under an Ar atmosphere in a 50 ml ZrO₂ vial including 15 ZrO₂ balls ( [symbol] =10 mm) at 600 rpm for 10 hours to synthesize LiCl·4Li₂TiF₆.

Subsequently, the LiCl·4Li₂TiF₆ is weighted to be included in an amount of 10 parts by weight based on 100 parts by weight of LiFe_{0.5}Mn_{1.5}O₄, and then, mechanically milled at 200 rpm for 1 hour under the same condition as above to prepare a composite positive electrode active material in which the LiCl·4Li₂TiF₆ is coated on the surface of the LiFe_{0.5}Mn_{1.5}O₄.

### Synthesis Example 2

A composite positive electrode active material is prepared in the same manner as in Synthesis Example 1 except that 10 parts by weight of LiCl·4Li₂TiF₆ based on 100 parts by weight of LiFe_{0.5}Mn_{1.5}O₄ is weighed and used.

### Synthesis Example 3

A composite positive electrode active material is prepared in the same manner as in Synthesis Example 1 except that 20 parts by weight of LiCl·4Li₂TiF₆ based on 100 parts by weight of LiFe_{0.5}Mn_{1.5}O₄ is weighed and used.

### Comparative Synthesis Example 1

A composite positive electrode active material in which Li₂TiF₆ is coated on the surface of LiFe_{0.5}Mn_{1.5}O₄ is prepared under the same condition as aforementioned in Synthesis Example 1 by weighing 10 parts by weight of Li₂TiF₆ based on 100 parts by weight of LiFe_{0.5}Mn_{1.5}O₄ and then, mechanically milling them.

### Comparative Synthesis Example 2

A composite positive electrode active material in which Li₃AlF₆ is coated on the surface of LiFe_{0.5}Mn_{1.5}O₄ is prepared under the same condition as aforementioned in Synthesis Example 1 except that 10 parts by weight of Li₃AlF₆ based on 100 parts by weight of LiFe_{0.5}Mn_{1.5}O₄ is weighed.

### Comparative Synthesis Example 3

First, LiCl·3Li₃AlF₆ is synthesized by weighing LiCl and Li₃AlF₆ to be included in a mole ratio of 1:3 and then, mechanically milled in a 50 ml ZrO₂ vial containing 15 ZrO₂ balls ( [symbol] =10 mm) at 600 rpm for 10 hours under an Ar atmosphere with Pulverisette 7 PL (Fritsch GmbH).

Subsequently, 10 parts by weight of the LiCl·3Li₃AlF₆ based on 100 parts by weight of LiFe_{0.5}Mn_{1.5}O₄ is weighed and mechanically milled under the same condition as aforementioned at 200 rpm for 1 hour to prepare a composite positive electrode active material in which the LiCl·3Li₃AlF₆ is coated on the surface of the LiFe_{0.5}Mn_{1.5}O₄.

### Comparative Synthesis Example 4

A composite positive electrode active material in which ZrO₂-2Li₂ZrCl₅F is coated on the surface of LiNi_{0.5}Mn_{1.5}O₄ is prepared under the same condition as aforementioned in Synthesis Example 1 by weighing 10 parts by weight of the ZrO₂-2Li₂ZrCl₅F based on 100 parts by weight of the LiFe_{0.5}Mn_{1.5}O₄.

TABLE 1

| | Composite positive electrode active material | | |
|---|---|---|---|
| | | Coating layer | |
| | | | Parts by weight of |
| | | | coating layer based |
| | | | on 100 parts by weight |
| | Positive electrode | | of positive electrode |
| | active material | Composition | active material |
| Synthesis Example 1 | LiFe_{0.5}Mn_{1.5}O₄ | LiCl•4Li₂TiF₆ | 5 parts by weight |
| Synthesis Example 2 | LiFe_{0.5}Mn_{1.5}O₄ | LiCl•4Li₂TiF₆ | 10 parts by weight |
| Synthesis Example 3 | LiFe_{0.5}Mn_{1.5}O₄ | LiCl•4Li₂TiF₆ | 20 parts by weight |
| Synthesis Example 4 | LiFe_{0.4}Al_{0.1}Mn_{1.5}O₄ | LiCl•4Li₂TiF₆ | 10 parts by weight |
| Comparative | LiFe_{0.5}Mn_{1.5}O₄ | Li₂TiF₆ | 10 parts by weight |
| Synthesis Example 1 | | | |
| Comparative | LiFe_{0.5}Mn_{1.5}O₄ | Li₃AlF₆ | 10 parts by weight |
| Synthesis Example 2 | | | |
| Comparative | LiFe_{0.5}Mn_{1.5}O₄ | LiCl•3Li₃AlF₆ | 10 parts by weight |
| Synthesis Example 3 | | | |
| Comparative | LiFe_{0.5}Mn_{1.5}O₄ | ZrO₂—2Li₂ZrCl₅F | 10 parts by weight |
| Synthesis Example 4 | | | |

### Evaluation Example 1: XRD Evaluation

XRD of LiCl·4Li₂TiF₆ and Li₂TiF₆ used as coating materials in Synthesis Example 1 and Comparative Synthesis Example 1, respectively, and LiCl·3Li₃AlF₆ and Li₃AlF₆ used as coating materials in Comparative Synthesis Example 3 and Comparative Synthesis Example 2, respectively, is analyzed by the following method.

First, samples are sealed by using a Be cover in a glove box under an argon atmosphere. An X-ray diffraction analyzer (Miniflex-600, Rigaku Corp.) as an X-ray diffraction measuring apparatus and Cu Kα as an X-ray source are used, and the measurement is performed at a step-size of 0.02° and a speed of 2.0 deg/min within a range of 10° to 80°.

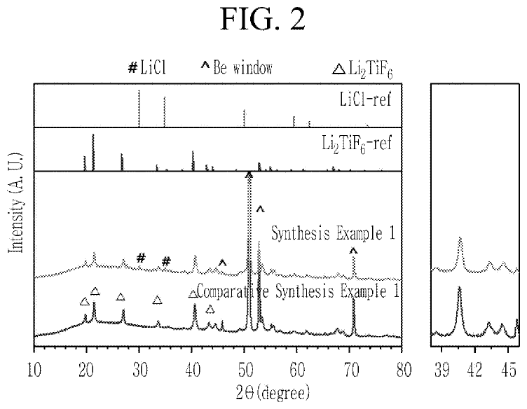

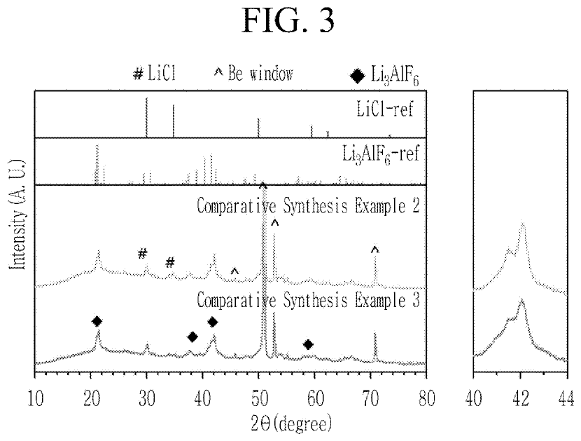

The measurement results are shown as a graph in FIGS. 2 and 3. For reference, the enlarged view at the right of FIG. 3 shows that an XRD peak is not shifted during the complexation process with LiCl in Comparative Synthesis Example 3. The enlarged view at the right of FIG. 2 shows that the XRD peak is shifted during the complexation process with LiCl in Synthesis Example 1.

Referring to FIG. 3, the coating material used in Comparative Synthesis Example 3 exhibit both peaks due to LiCl and Li₃AlF₆, whereas the coating material used in Comparative Synthesis Example 2 exhibits a peak due to Li₃AlF₆. Referring to FIG. 2, the coating material used in Synthesis Example 1 exhibits both peaks due to LiCl and Li₂TiF₆, whereas the coating material used in Comparative Synthesis Example 1 exhibits a peak due to Li₂TiF₆ alone.

### Evaluation Example 2: Ionic Conductivity Evaluation

The lithium ionic conductivity of LiCl·4Li₂TiF₆ and Li₂TiF₆ used as coating materials in Synthesis Example 1 and Comparative Synthesis Example 1, and LiCl·3Li₃AlF₆ and Li₃AlF₆ used as coating materials in Comparative Synthesis Example 3 and Comparative Synthesis Example 2, is measured by the following impedance method.

First, the samples are respectively appropriately weighed in a glove box under an argon atmosphere and placed in a polyetheretherketone pipe (a PEEK pipe with an interior diameter of 13 mm, an exterior diameter of 32 mm, and a height of 10 mm), whose upper and lower parts are clicked in contact with a powder-molding jig including Ti. Subsequently, the samples are molded into pellets with a diameter of 13 mm and any thickness at a molding pressure of 370 MPa by using a single-axis press. Then, the obtained pellets are placed in a sealed electrochemical cell capable of maintaining the argon atmosphere.

The measurement is performed by using Impedance/Gain-Phase Analyzer, SP-300 made by Bio-Logic SAS, as a frequency response analyzer (FRA) and a small environment tester as a temperature control device. The measurement is initiated from a high frequency region under conditions of an AC voltage of 10 mV to 100 mV, a frequency range of 10 Hz to 7 MHz, and a temperature of 30° C.

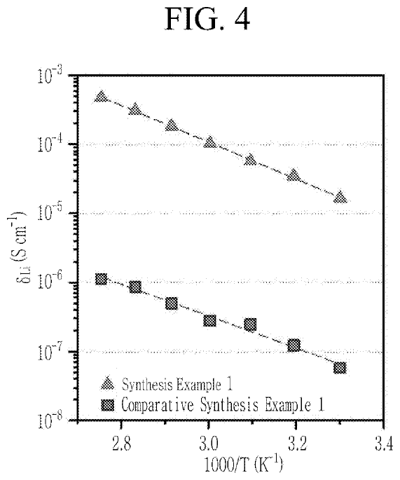

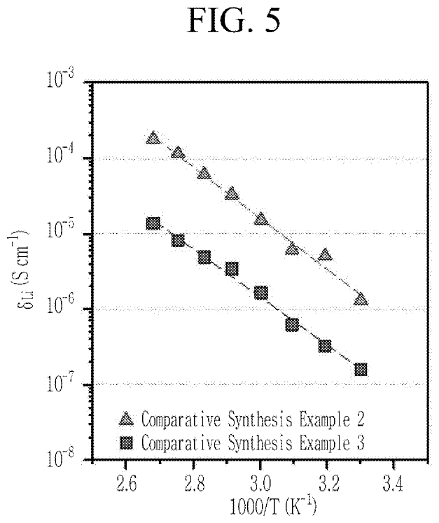

The measurement results are shown as graphs of FIGS. 4 and 5.

Referring to FIGS. 4 and 5, the lithium metal fluoride-based compounds (LiCl·3Li₃AlF₆ and LiCl·4Li₂TiF₆) respectively prepared by complexing the lithium chloride-based compounds used in Comparative Synthesis Example 3 and Synthesis Example 1 are confirmed to exhibit excellent lithium ion conductivity, compared with those obtained by complexing the lithium metal fluoride-based compounds (Li₃AlF₆ and 4Li₂TiF₆) used in Comparative Synthesis Examples 1 and 2.

The ion conductivity results of the coating materials of Synthesis Example 1 and Comparative Synthesis Examples 1 to 3 are shown in Table 2.

TABLE 2

| | | Ionic conductivity |
|---|---|---|
| | Composition | (S cm⁻¹, 30° C.) |
| Synthesis Example 1 | LiCl—Li₂TiF₆ | 1.7 × 10⁻⁵ |
| Comparative Synthesis Example 1 | Li₂TiF₆ | 5.8 × 10⁻⁸ |
| Comparative Synthesis Example 2 | LI₃AlF₆ | 1.7 × 10⁻⁷ |
| Comparative Synthesis Example 3 | LiCl•3Li₃AlF₆ | 1.2 × 10⁻⁶ |

Referring to Table 2, Comparative Synthesis Examples 1 to 3 were confirmed to exhibit high ion conductivity of LiCl·4Li₂TiF₆, compared to Synthesis Example 1. On the other hand, compared to Comparative Synthesis Example 1 using Li₂TiF₆ alone as the coating material, Synthesis Example 1 using LiCl·Li₂TiF₆ as the coating material was confirmed to exhibit superbly high ion conductivity of the coating material.

### Evaluation Example 3: Electrochemical Stability Evaluation

The coating materials are evaluated with respect to electrochemical stability by performing cyclic voltammetry within a voltage range of 3 V to 5 V.

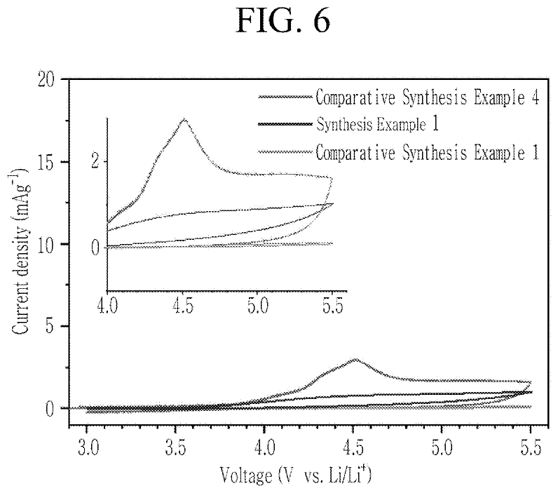

The cyclic voltammetry results of Li₂TiF₆, LiCl·4Li₂TiF₆, and ZrO₂-2Li₂ZrCl₅F used as the coating materials in Synthesis Example 1 and Comparative Synthesis Examples 1 to 4 are shown in FIG. 6.

Referring to FIG. 6, the LiCl·4Li₂TiF₆ is confirmed to exhibit excellent electrochemical stability.

### Evaluation Example 4: SEM Analysis and Elemental Mapping

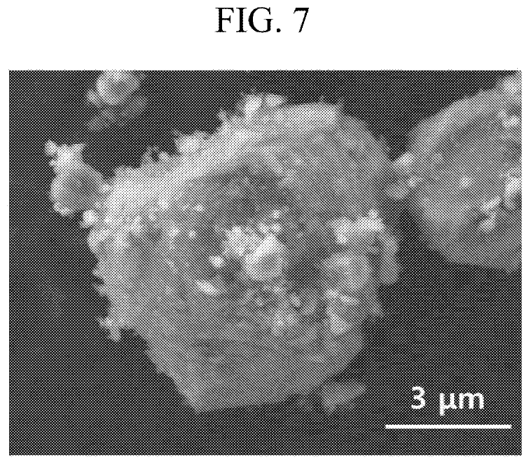

FIG. 7 is a scanning electron microscope (SEM) image of the composite positive electrode active material according to Synthesis Example 4.

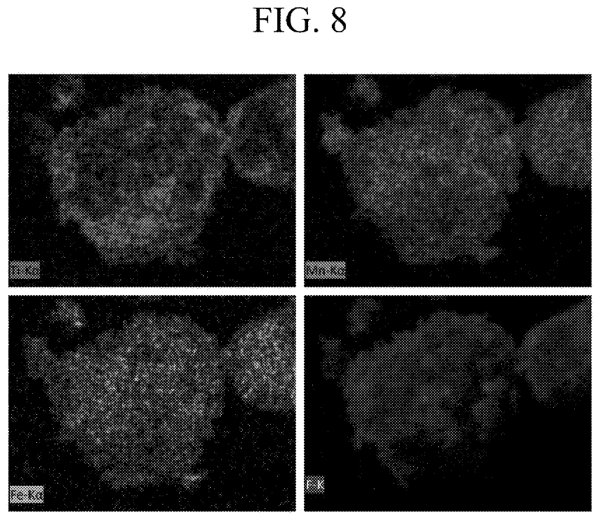

FIG. 8 is (a) an image showing the composite positive electrode active material of Synthesis Example 4 through SEM-EDS (Energy Dispersive Spectrometer) analysis, (b) an image of mapping Ti, (c) an image of mapping Fe, and (d) an image of mapping Fe and Ti.

Referring to FIG. 7, the coating material (LiCl·4Li₂TiF₆) is formed on the surface of LiFe_{0.5}Mn_{1.5}O₄.

In addition, referring to FIG. 8(a), a relatively darker portion corresponds to LiFe_{0.5}Mn_{1.5}O₄, and a relatively brighter portion corresponds to the coated material.

Referring to FIGS. 8(b) to 8(d), the SEM-EDS elemental analysis results confirm that Ti is distributed in the coated material.

### Evaluation Example 5: XPS Analysis

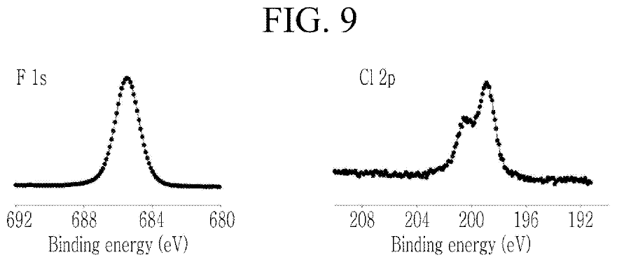

The composite positive electrode active material of Synthesis Example 4 is subjected to X-ray Photoelectron Spectroscopy (XPS) analysis, and the result is shown in FIG. 9.

In FIG. 9, (a) is an XPS graph of LiCl·4Li₂TiF₆, (b) is an XPS graph of the composite positive electrode active material (Synthesis Example 2) in which LiCl·4Li₂TiF₆ is coated on LiFe_{0.5}Mn_{1.5}O₄, and (c) an XPS graph of LiFe_{0.5}Mn_{1.5}O₄.

Referring to FIG. 9, the composite positive electrode active material of Synthesis Example 2 is confirmed to include peaks exhibiting defects in the LiCl·4Li₂TiF₆ structure.

(Example: Manufacturing of all-Solid-State Battery Cell)

### Examples 1 to 3

48.5 wt % of each of the composite positive electrode active materials according to Synthesis Examples 1 to 3, 48.5 wt % of a solid electrolyte (ZrO₂-2Li₂ZrCl₅F), and 3 wt % of a conductive material (Super-C) are mixed to prepare a positive electrode.

Subsequently, a solid electrolyte layer including a Li₆PS₅Cl solid electrolyte and negative electrode including a Li—In negative electrode active material are prepared.

30 μm of the positive electrode, 600 μm of the solid electrolyte layer, and 100 μm of the negative electrode are stacked and compressed to manufacture all-solid-state battery cells according to Examples 1 to 3.

### Example 4

An all-solid-state battery cell is manufactured in the same manner as in Examples 1 to 3 except that the composite positive electrode active material according to Synthesis Example 4 is used.

### Comparative Examples 1 to 6

Each all-solid-state battery cell is manufactured in the same manner as in Examples 1 to 3 except that the composite positive electrode active materials according to Comparative Synthesis Examples 1 to 6 are respectively used.

### Evaluation Example 6: Evaluation of Charge/Discharge Characteristics and Cycle-Life Characteristics

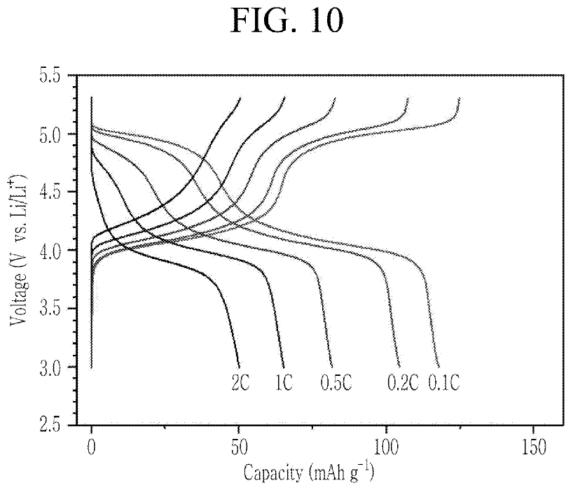

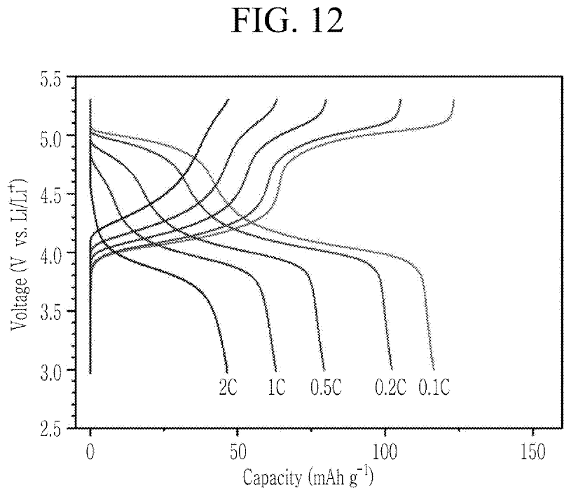

The all-solid-state battery cells according to Examples 1 to 3 were evaluated for their initial rate characteristics. The cells were repetitively charged to 5.3 V and discharged to 3.0 V at rates of 0.1 C, 0.2 C, 0.5 C, 1 C, and 2 C in an environment of 30° C. The results for Examples 1, 2, and 3 are shown in FIGS. 10, 11, and 12, respectively.

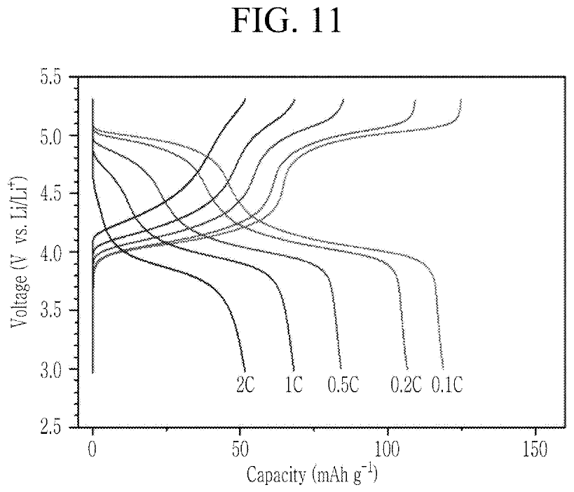

Referring to FIGS. 10 to 12, the all-solid-state battery cells of Examples 1 to 3, which include the composite positive electrode active material according to an embodiment, are confirmed to exhibit excellent charge and discharge characteristics. Particularly, the cell of Example 2 (FIG. 11) is confirmed to exhibit the most excellent performance.

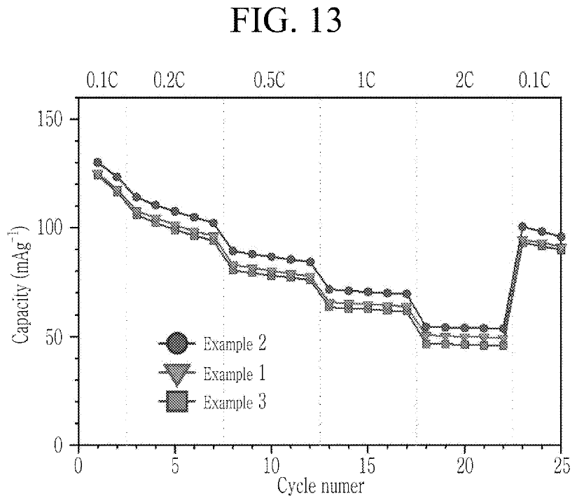

FIG. 13 shows the capacity recovery characteristics after the rate capability test for the all-solid-state battery cell of Example 2 as a representative case. As shown, the cell exhibits excellent rate characteristics and capacity recovery.

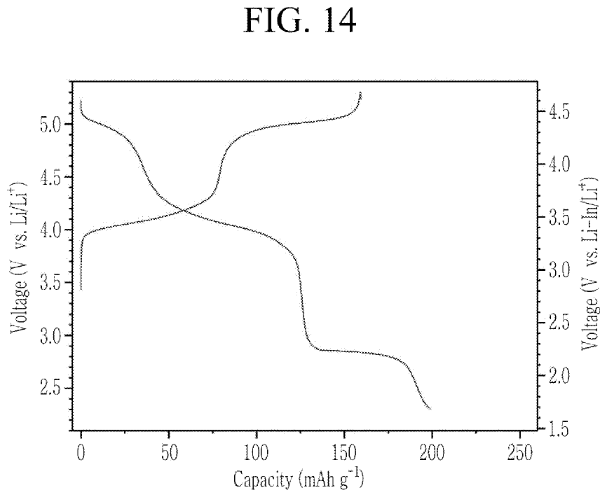

Furthermore, the all-solid-state battery cell of Example 2 was evaluated under a wider voltage window. The cell was constant-current charged to 5.3 V and then discharged to 2.3 V at 0.1 C in an environment of 60° C. The initial charge and discharge characteristics are shown in FIG. 14.

Referring to FIG. 14, the all-solid-state battery cell of Example 2 is confirmed to exhibit excellent charge and discharge characteristics even when operated with a lower discharge voltage of 2.3 V.

For comparison, the all-solid-state battery cells of Comparative Examples 1 to 4 were also evaluated.

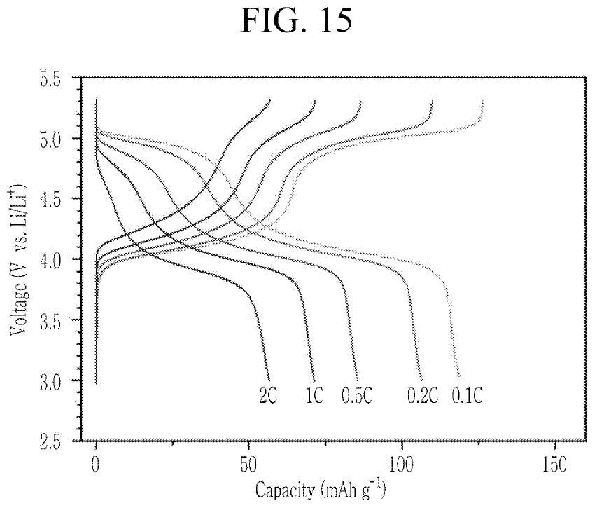

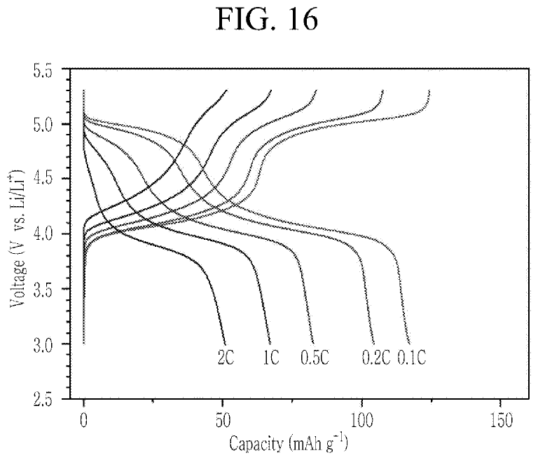

FIG. 15 and FIG. 16 show the initial charge/discharge characteristics of the cells from Comparative Example 1 and Comparative Example 2, respectively, evaluated under the same conditions as in FIGS. 10-12.

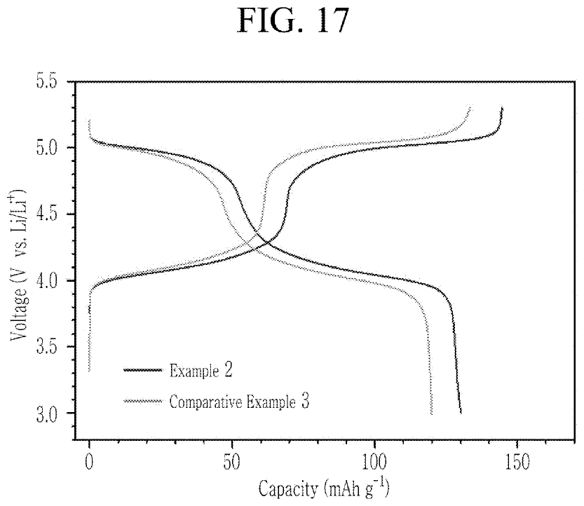

FIG. 17 compares the initial discharge capacity of the cell from Example 2 with that of Comparative Example 3 at 0.1C. The cell of Example 2 exhibits a high initial discharge capacity, whereas the cell of Comparative Example 3 shows a lower capacity.

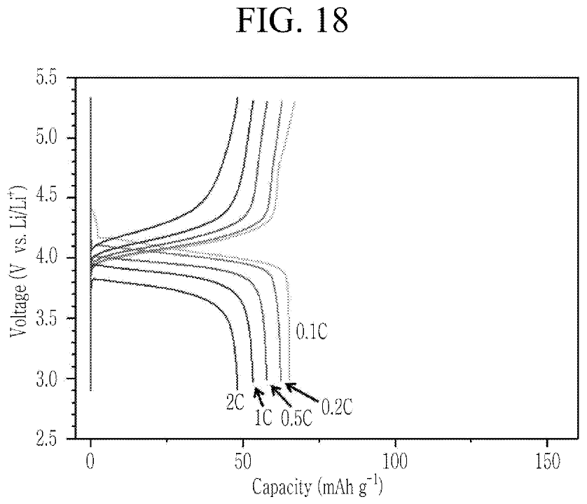

FIG. 18 compares the rate characteristics of the cell from Example 2 with that of Comparative Example 4. The cell according to Comparative Example 4 exhibits a very low initial discharge capacity and significantly deteriorated rate characteristics compared to the cell of Example 2.

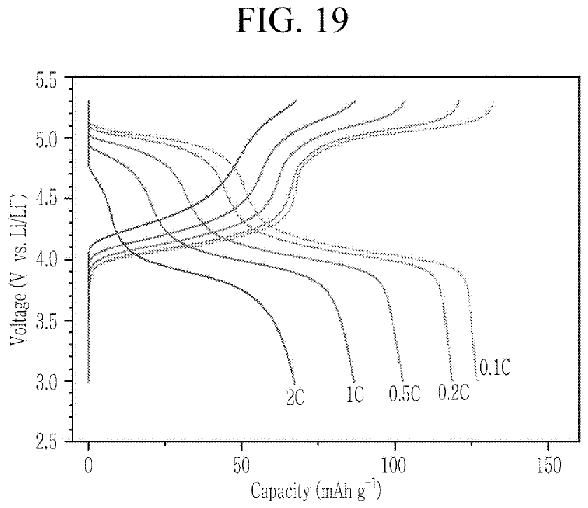

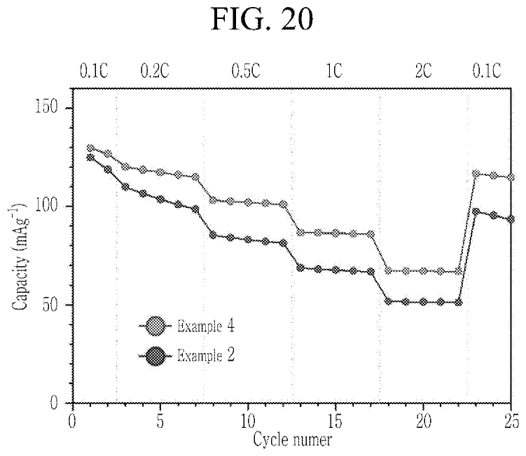

Additionally, the initial charge/discharge characteristics of the all-solid-state battery cells from Example 2 and Example 4 were evaluated, and the results are shown in FIG. 19 and FIG. 20, respectively.

To evaluate cycle-life characteristics, the cells of Example 2 and Example 4 were subjected to 25 charge-discharge cycles. These results demonstrated excellent cycle performance.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

100: all-solid-state battery
200: positive electrode
201: positive electrode current collector
203: positive electrode active material layer
300: solid electrolyte layer
400: negative electrode
401: negative current collector
403: negative electrode active material layer
500: elastic layer

What is claimed is:

1. A composite positive electrode active material, comprising
a positive electrode active material represented by Chemical Formula 1; and
a coating layer disposed on a surface of the positive electrode active material and including a compound represented by Chemical Formula 2: 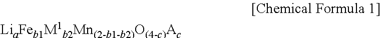
wherein, in Chemical Formula 1,
M1 is Mg, B, Al, or a combination thereof;
A is F, Cl, Br, I, or a combination thereof;
1≤a≤2, 0≤b1<2, 0≤b2<2, (2-b1-b2)>0, and 0≤c<4; 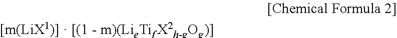
wherein, in Chemical Formula 2,
X¹ and X² are each independently F, Cl, Br, I, or a combination thereof;
0.01≤e≤10, 0.01≤f≤10, 0≤g<h, and 0<m<1.

2. The composite positive electrode active material of claim 1, wherein
the positive electrode active material is LiFe_{0.5}Mn_{1.5}O₄ or LiFe_{0.4}Al_{0.1}Mn_{1.5}O₄:

3. The composite positive electrode active material of claim 1, wherein
the compound represented by Chemical Formula 2 comprises a compound represented by Chemical Formula 2A: 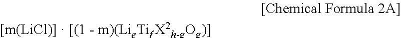
wherein, in Chemical Formula 2A,
0.01≤e≤10, 0.01≤f≤10, 0≤g<h, and 0<m<1.

4. The composite positive electrode active material of claim 1, wherein
m and (1-m) of the compound represented by Chemical Formula 2 are in a molar ratio of 1:1 to 1:9.

5. The composite positive electrode active material of claim 1, wherein
the compound represented by Chemical Formula 1 is LiCl·4Li₂TiF₆.

6. The composite positive electrode active material of claim 1, wherein
based on 100 parts by weight of the positive electrode active material,
the coating layer is included in an amount of 1 part by weight to 20 parts by weight.

7. The composite positive electrode active material of claim 1, wherein
the compound represented by Chemical Formula 2 has a lithium ionic conductivity of greater than or equal to 1.0×10⁻⁶ S/cm.

8. A positive electrode, comprising
a positive electrode current collector; and
a positive electrode active material layer on the positive electrode current collector,
wherein the positive electrode active material layer comprises a composite positive electrode active material including a positive electrode active material, and a coating layer disposed on a surface of the positive electrode active material and including a compound represented by Chemical Formula 2: 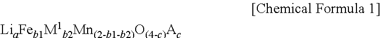
wherein, in Chemical Formula 1,
M1 is Mg, B, Al, or a combination thereof;
A is F, Cl, Br, I, or a combination thereof;
1≤a≤2, 0<b1<2, 0≤b2<2, (2-b1-b2)>0, and 0≤c<4; 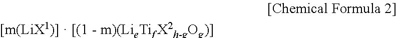
wherein, in Chemical Formula 2,
X¹ and X² are each independently F, Cl, Br, I, or a combination thereof;
0.01≤e≤10, 0.01≤f≤10, 0≤g<h, and 0<m<1.

9. The positive electrode of claim 8, wherein
the positive electrode active material layer further comprises a solid electrolyte, and the solid electrolyte is a halide-based solid electrolyte.

10. An all-solid-state battery, comprising
the positive electrode of claim 8;
a negative electrode; and
a solid electrolyte layer between the positive electrode and the negative electrode.

11. The all-solid-state battery of claim 10, wherein
the solid electrolyte layer comprises a sulfide-based solid electrolyte, and
the sulfide-based solid electrolyte comprises an argyrodite-type sulfide-based solid electrolyte.

12. The all-solid-state battery of claim 10, wherein
a charge voltage of the all-solid-state battery is greater than or equal to 4.2 V.

13. The all-solid-state battery of claim 10, wherein
a discharge voltage of the all-solid-state battery is less than or equal to 3.5 V.
